(19) United States
(12) Patent Application Publication
(10) Pub. No.: US 2026/0055015 A1
(43) Pub. Date: Feb. 26, 2026

(54) USE OF POLYCARBOXYLATED-BETA-AMINO ALCOHOLS FOR DISSOLUTION OF INORGANIC SALTS

(71) Applicant: ECOLAB USA Inc., St. Paul, MN (US)

(72) Inventors: Ashish DHAWAN, Aurora, IL (US); Carter Martin SILVERNAIL, Lakeville, MN (US)

(73) Assignee: ECOLAB USA Inc., St. Paul, MN (US)

(21) Appl. No.: 19/305,058

(22) Filed: Aug. 20, 2025

Related U.S. Application Data
(60) Provisional application No. 63/686,373, filed on Aug. 23, 2024.

(51) Int. Cl. C02F 5/12; C02F 101/20; C02F 103/10; C08F 126/00

(52) U.S. Cl. CPC C02F 5/12; C08F 126/00; C02F 2101/203; C02F 2103/10; C02F 2305/00

(57) ABSTRACT

The present disclosure provides methods and compositions for dissolving inorganic salt deposits, such as iron sulfide deposits, in aqueous systems. A method may include adding a polycarboxylated β-amino alcohol polymer to the aqueous medium. The polycarboxylated β-amino alcohol polymer may be added by itself or as part of a composition. The composition may optionally include a solvent and/or an additive. The compositions and methods may be used for dissolving typical insoluble inorganic salts encountered in the oil and gas, recovery, water, and processing industries.

### TECHNICAL FIELD

The present disclosure provides compositions and methods for effectively dissolving insoluble inorganic salts encountered in the oil and gas, recovery, water, and processing industries. More specifically, the disclosure pertains to compositions including a polycarboxylated amino alcohol and methods of using the compositions to dissolve iron sulfide.

### BACKGROUND

As oilfields age, the amount of oil produced decreases and the amount of water produced with the oil increases. The water is usually disposed of or injected back into the formation to maintain reservoir pressure. The separation process is efficient, but not perfect, and a small fraction of oil and other debris can be present after the fluids pass through the separation equipment. That residual fraction of oil in water carryover can cause significant problems as the field ages.

The deposition of in situ inorganic salts and residual oils, such as paraffin, asphaltenes, iron sulfide, and biomass can build up in the separation equipment and pipelines. Formation of iron sulfide on this equipment is problematic due to low solubility of iron sulfide in aqueous media, and no solubility in hydrocarbon streams, which causes the iron sulfide salt to precipitate out of solution and deposit on the surfaces of the processing equipment. The deposition of iron sulfide leads to the fouling of the equipment. If left untreated, the foulant material results in the blockage of pipelines and the inefficient operations of the process, which can lead to loss of revenue due to costly mechanical remedial measures and/or equipment failure.

In addition to plugging lines, deposits comprising iron sulfide may collect on internal surfaces. Such unwanted deposits may be complex mixtures of inorganic compounds, such as sand and iron sulfide, and organic compounds, such as asphaltenes and crude petroleum. The deposits are sticky and difficult to clean. Currently available cleaners for removing deposits from equipment used in oil and gas applications aid in the removal of the organic deposition but are less effective against the inorganic deposition, especially iron sulfide.

Conventional cleaners may disperse iron sulfide, but are relatively ineffective in inhibiting or dissolving iron sulfide, providing only limited cleaning ability. Conventional cleaners may also be acidic and therefore incompatible with the metallurgy of the systems they are designed to treat.

### BRIEF SUMMARY

The present disclosure provides compositions and methods for dissolving inorganic salt deposits in an aqueous medium.

In some embodiments, the disclosure provides a method of dissolving an inorganic salt deposit in an aqueous medium. The method comprises adding a polycarboxylated-amino alcohol polymer to the aqueous medium and dissolving at least a portion of the inorganic salt deposit.

The present disclosure also provides a composition for dissolving an inorganic salt deposit in an aqueous medium. The composition comprises a polycarboxylated β-amino alcohol polymer.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1A shows an embodiment of a polycarboxylated β-amino alcohol synthesized with one mole of epoxysuccinic acid;

FIG. 1B shows an embodiment of a polycarboxylated β-amino alcohol structure synthesized with two moles of epoxysuccinic acid;

FIG. 1C shows an embodiment of a polycarboxylated β-amino alcohol structure synthesized with three moles of epoxysuccinic acid;

FIG. 2A shows an example of a synthetic route that produces the polycarboxylated β-amino alcohol of FIG. 1A;

FIG. 2B shows an example of a synthetic route that produces the polycarboxylated β-amino alcohol of FIG. 1B;

FIG. 3 shows the results of an iron sulfide solubilization performance test for various 1:1 adducts;

FIG. 4 shows the results of an iron sulfide solubilization performance test for various 1:2 adducts; and

FIG. 5 shows comparative results of the iron sulfide solubilization performance tests for the 1:1 adducts and 1:2 adducts.

### DETAILED DESCRIPTION

Unless otherwise defined, all technical and scientific terms used herein have the same meaning as commonly understood by one of ordinary skill in the art. In case of conflict, the present document, including definitions, will control. Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)-groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A}) (R_{B}), wherein R_{A} and R_{B} are independently hydrogen, alkyl, or aryl), halo(fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions for removing, dissolving, inhibiting formation of, etc., typically insoluble inorganic salts, such as iron sulfide, in the oil and gas, recovery, water, and processing industries. In some embodiments, a composition comprises an inorganic salt dissolver, which is capable of dissolving iron sulfide and other inorganic salts, and may interchangeably be referred to herein as an iron sulfide dissolver. It is to be understood that while the iron sulfide dissolver can dissolve iron sulfide, it can dissolve other inorganic salts as well, such as lead sulfide, zinc sulfide, or a mixture of lead sulfide and zinc sulfide.

The iron sulfide dissolver includes a polycarboxylated polymer and/or a salt thereof. Compositions disclosed herein may optionally comprise other components, such as an additive and/or a solvent (e.g., an organic solvent). In some embodiments, the compositions disclosed herein exclude a solvent, an additive, such as a corrosion inhibitor, and/or phosphorous.

The compositions disclosed herein are useful in, for example, crude oil-based and natural gas-based products, processes, and refinery streams. The compositions are useful for removing hydrocarbonaceous deposits and/or inorganic salts (e.g., iron sulfide) from metallic and/or mineral surfaces in contact with a fluid in oil and/or gas applications. The compositions can be used in sweet systems (i.e., systems having a relatively high carbon dioxide concentration) or in systems having sour conditions (i.e., relatively high hydrogen sulfide concentration). The compositions are useful in a wide range of climates and under a wide range of process conditions, such as from about 0° C. to about 200° C., where other available cleaner compositions fail.

In some embodiments, the polycarboxylated polymer comprises a compound from the following Formula I:

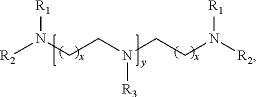

wherein x is an integer from about 1 to about 10 (such as about 2, 3, 4, 5, 6, 7, 8, or 9); y is an integer from about 0 to about 100 (such as about 0 to about 75, about 0 to about 50, about 0 to about 25, about 1 to about 75, about 1 to about 50, about 1 to about 25, about 1 to about 10, about 25 to about 100, about 50 to about 100, or about 75 to about 100); R₁=CH(COOM)-CH(OH)(COOM); R₂=H or R₁; R₃=R₂ or −(CH₂)z-NR₁R₂; z is an integer from about 1 to about 10 (such as about 2, 3, 4, 5, 6, 7, 8, or 9); and M=H, Na, K, or Li.

The polycarboxylated polymer may include a polycarboxylated β-amino alcohol, for example. The polycarboxylated β-amino alcohol may be used for mitigating fouling of process equipment caused by an iron sulfide foulant, for example. Illustrative, non-limiting examples of polycarboxylated polymers include:

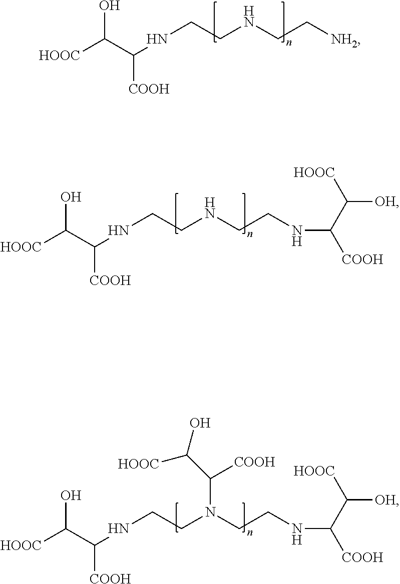

or any combination of the foregoing. The “n” variable in each formula may be independently selected from 0 to about 1,000, such as from 0 to about 800, from 0 to about 600, from 0 to about 400, from 0 to about 200, from 0 to about 100, from 0 to about 50, from 0 to about 25, from 1 to about 25, from 1 to about 50, from 1 to about 100, from 1 to about 300, from 1 to about 500, from 1 to about 700, or from 1 to about 900.

A polycarboxylated β-amino alcohol of the present disclosure may be synthesized, for example, by reacting an epoxide with a polyamine in various molar ratios, such as about 50:1, about 40:1, about 30:1, about 20:1, about 10:1, about 5:1, about 4:1, about 3:1, about 2:1, about 1:1, about 1:2, about 1:3, about 1:4, about 1:5, about 1:10, about 1:20, about 1:30, about 1:40, about 1:50, etc.

The epoxide is not particularly limited and may be selected from, for example, epoxysuccinic acid, oxyglutaric acid, and epoxyadipic acid.

Illustrative, non-limiting examples of the polyamine include pentaethylenehexamine (PEHA), tetraethylenepentamine (TEPA), triethylenetetramine (TETA), diethylenetriamine (DETA), ethylenediamine (EDA), tris(2-aminoethyl)amine, and tris(2-aminopropyl)amine polyethylenimine, and any combination thereof.

Table 1 shows various reactants and their molar ratios that may be used to prepare a polycarboxylated β-amino alcohol of the present disclosure. In accordance with the present disclosure, Compound I may be referred to as a “1:1 adduct” and Compound V may be referred to as a “2:1 adduct.”

TABLE 1

| Compound | | | Epoxide:Amine |
|---|---|---|---|
| ID | Epoxide | Polyamine | mole ratio |
| I | Epoxysuccinic acid | PEHA | 1:1 |
| II | Epoxysuccinic acid | TEPA | 1:1 |
| III | Epoxysuccinic acid | TETA | 1:1 |
| IV | Epoxysuccinic acid | DETA | 1:1 |
| V | Epoxysuccinic acid | PEHA | 2:1 |
| VI | Epoxysuccinic acid | TEPA | 2:1 |
| VII | Epoxysuccinic acid | TETA | 2:1 |
| VII | Epoxysuccinic acid | DETA | 2:1 |

The polycarboxylated β-amino alcohol disclosed herein may be fully neutralized, partially neutralized, or not neutralized at all.

The weight average molecular weight of the polycarboxylated β-amino alcohol of the present disclosure is not particularly limited. In some embodiments, the polycarboxylated 3-amino alcohol comprises a molecular weight of about 200 Da to about 50,000 Da. For example, the molecular weight may be from about 500 Da to about 50,000 Da, from about 1,000 Da to about 50,000 Da, from about 10,000 Da to about 50,000 Da, from about 25,000 Da to about 50,000 Da, from about 200 Da to about 25,000 Da, from about 200 Da to about 10,000 Da, from about 200 Da to about 5,000 Da, from about 200 Da to about 1,000 Da, from about 5,000 Da to about 15,000 Da, or from about 10,000 Da to about 30,000 Da.

Compositions disclosed herein may comprise a polycarboxylated β-amino alcohol and/or a salt of a polycarboxylated β-amino alcohol. Suitable salts include, but are not limited to, alkali metal and alkaline earth metal salts, such as sodium, potassium, lithium, magnesium, calcium and cesium salts.

The iron sulfide dissolver may be present in a composition when being added to a medium of an industrial process or the iron sulfide dissolver may be added neat/alone to the medium. If present in a composition, the amount of the iron sulfide dissolver in the composition may range from about 0.1 wt. % to about 99 wt. %, such as from about 0.1 wt. % to about 90 wt. %, about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 5 wt. % to about 99 wt. %, about 10 wt. % to about 99 wt. %, about 20 wt. % to about 99 wt. %, about 30 wt. % to about 99 wt. %, about 40 wt. % to about 99 wt. %, about 1 wt. % to about 99 wt. %, about 1 wt. % to about 75 wt. %, about 1 wt. % to about 50 wt. %, or about 1 wt. % to about 25 wt. %, based on total weight of the composition.

The compositions disclosed herein may optionally include an additive. Suitable additives include, but are not limited to, an asphaltene inhibitor, a paraffin inhibitor, a scale inhibitor, an emulsifier, a water clarifier, a dispersant, an emulsion breaker, a hydrogen sulfide scavenger, a sulfur-containing compound, a gas hydrate inhibitor, a biocide, an antifoam, a pH modifier, a corrosion inhibitor and/or a surfactant.

Suitable corrosion inhibitors include, but are not limited to, alkyl, hydroxyalkyl, alkylaryl, arylalkyl or arylamine quaternary salts, mono or polycyclic aromatic amine salts, imidazoline derivatives, mono-, di- or trialkyl or alkylaryl phosphate esters, phosphate esters of hydroxylamines, phosphate esters of polyols, an ester of alcoholamine, an alkoxylated amine and/or monomeric and/or oligomeric fatty acids.

In some embodiments, the corrosion inhibitor comprises an imidazoline. The imidazoline may be, for example, imidazoline derived from a diamine, such as ethylene diamine (EDA), DETA, TETA, etc., and a long chain fatty acid, such as tall oil fatty acid (TOFA).

Suitable sulfur-containing compounds include, but are not limited to, compounds that enhance the corrosion inhibiting and/or cleaning performance of the composition. The sulfur-containing compound may include, for example, thioglycolic acid, 3,3′-dithiodipropionic acid, thiourea, 2-mercaptoethanol, L-cysteine, tert-butyl mercaptan, sodium thiosulfate, ammonium thiosulfate, sodium thiocyanate, ammonium thiocyanate, sodium metabisulfite, or any combination thereof. In some embodiments, the sulfur-containing compound is 2-mercaptoethanol.

Suitable asphaltene inhibitors include, but are not limited to, aliphatic sulfonic acids, alkyl aryl sulfonic acids, aryl sulfonates, lignosulfonates, alkylphenol/aldehyde resins and/or similar sulfonated resins, polyolefin esters, polyolefin imides, polyolefin esters with alkyl, alkylenephenyl or alkylenepyridyl functional groups, polyolefin amides, polyolefin amides with alkyl, alkylenephenyl or alkylenepyridyl functional groups, polyolefin imides with alkyl, alkylenephenyl or alkylenepyridyl functional groups, alkenyl/vinyl pyrrolidone copolymers, graft polymers of polyolefins with maleic anhydride or vinyl imidazole, hyperbranched polyester amides, polyalkoxylated asphaltenes, amphoteric fatty acids, salts of alkyl succinates, sorbitan monooleate, and polyisobutylene succinic anhydride.

Suitable paraffin inhibitors include, but are not limited to, paraffin crystal modifiers and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes.

Suitable scale inhibitors include, but are not limited to, phosphates, phosphate esters, phosphoric acids, phosphonates, phosphonic acids, polyacrylam ides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS).

Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

Suitable water clarifiers include, but are not limited to, inorganic metal salts such as alum, aluminum chloride, and aluminum chlorohydrate, or organic polymers such as acrylic acid-based polymers, acrylamide-based polymers, polymerized amines, alkanolamines, thiocarbamates, and cationic polymers, such as diallyldimethylammonium chloride (DADMAC).

Suitable dispersants include, but are not limited to, aliphatic phosphonic acids with 2-50 carbons, such as hydroxyethyl diphosphonic acid, and aminoalkyl phosphonic acids, e.g., polyaminomethylene phosphonates with 2-10 N atoms, each bearing at least one methylene phosphonic acid group, examples of the latter including ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersants include lignin, or derivatives of lignin, such as lignosulfonate and naphthalene sulfonic acid and derivatives. In some embodiments, a dispersant is selected from dodecyl benzene sulfonate, an oxyalkylated alkylphenol, and/or an oxyalkylated alkylphenolic resin.

Suitable emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, and resins, such as phenolic and epoxide resins.

Suitable hydrogen sulfide scavengers include, but are not limited to, oxidants (e.g., inorganic peroxides, such as sodium peroxide or chlorine dioxide); aldehydes (e.g., of 1-10 carbons, such as formaldehyde, glyoxal, glutaraldehyde, acrolein, or methacrolein; and triazines (e.g., monoethanolamine triazine, monomethylamine triazine, and triazines from multiple amines or mixtures thereof).

Suitable gas hydrate inhibitors include, but are not limited to, thermodynamic hydrate inhibitors, kinetic hydrate inhibitors, and anti-agglomerates. Suitable thermodynamic hydrate inhibitors include, but are not limited to, sodium chloride, potassium chloride, calcium chloride, magnesium chloride, sodium bromide, formate brines (e.g., potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, and triglycerol), sugar alcohols (e.g., sorbitol and mannitol), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

Suitable kinetic hydrate inhibitors and anti-agglomerates include, but are not limited to, polymers and copolymers, polysaccharides (such as hydroxyethylcellulose, carboxymethylcellulose, starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, and alkyl amido betaines), hydrocarbon-based dispersants (such as lignosulfonates, iminodisuccinates, and polyaspartates), amino acids, and proteins.

Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. For example, a pH modifier may include sodium hydroxide, potassium hydroxide, calcium hydroxide, calcium oxide, sodium carbonate, potassium carbonate, sodium bicarbonate, potassium bicarbonate, magnesium oxide, and magnesium hydroxide. In some embodiments, a pH modifier may comprise a hydrophilic or amphiphilic amine, such as methyldiethanolamine (MDEA).

Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, alkyl and ethoxylated alkyl phosphate esters, and mono- and dialkyl sulfosuccinates and sulfosuccinamates. Nonionic surfactants include, but are not limited to, alcohol alkoxylates, alkylphenol alkoxylates, block copolymers of ethylene, propylene and butylene oxides, alkyl dimethyl amine oxides, alkyl-bis(2-hydroxyethyl)amine oxides, alkyl amidopropyl dimethyl amine oxides, alkylamidopropyl-bis(2-hydroxyethyl)amine oxides, alkyl polyglucosides, polyalkoxylated glycerides, sorbitan esters and polyalkoxylated sorbitan esters, and alkoxyl polyethylene glycol esters and diesters. Also included are betaines and sultanes, amphoteric surfactants, such as alkyl amphoacetates and amphodiacetates, alkyl amphopropionates and amphodipropionates, and alkyliminodipropionate.

The surfactant may be a quaternary ammonium compound, an amine oxide, an ionic or nonionic surfactant, or any combination thereof. Suitable quaternary ammonium compounds include, but are not limited to, alkyl benzyl ammonium chloride, benzyl cocoalkyl (C₁₂-C₁₈) dimethylammonium chloride, dicocoalkyl (C₁₂-C₁₈) dimethylammonium chloride, ditallow dimethylammonium chloride, di(hydrogenated tallow alkyl) dimethyl quaternary ammonium methyl chloride, methyl bis(2-hydroxyethyl cocoalkyl (C₁₂-C₁₈) quaternary ammonium chloride, dimethyl (2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhexyl) dimethyl quaternary ammonium methyl sulfate.

An additive may optionally comprise a multi-functional hydroxy-carboxylic acid and/or additional components, such as allaric acid, altaric acid, altraric acid, altronic acid, arabinaric acid, arabinonic acid, citric acid, dihomocitric acid, fructuronic acid, fuconic acid, fumaric acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, xyluronic acid, tartaric acid, tatronic acid, glyceric acid, malonic acid and pantoic acid, a salt of any of these acids, or any combination thereof.

The amount of additive present in a composition of the present disclosure is not particularly limited. For example, a composition disclosed herein may comprise from about 0 wt. % to about 99 wt. %, from about 0.1 wt. % to about 90 wt. %, from about 0.1 wt. % to about 80 wt. %, from about 0.1 wt. % to about 70 wt. %, from about 0.1 wt. % to about 60 wt. %, from about 0.1 wt. % to about 50 wt. %, from about 0.1 wt. % to about 40 wt. %, from about 0.1 wt. % to about 30 wt. %, from about 0.1 wt. % to about 20 wt. %, from about 0.1 wt. % to about 10 wt. %, from about 0.1 wt. % to about 5 wt. %, or from about 0.5 wt. % to about 3 wt. % of the additive or any combination of additives.

A composition of the present disclosure may include a solvent. Illustrative, non-limiting examples of solvents include an alcohol, a hydrocarbon, a ketone, an ether, an alkylene glycol, a glycol ether, an amide, a nitrile, a sulfoxide, an ester, and water. The solvent may comprise water, isopropanol, methanol, ethanol, 2-ethylhexanol, heavy aromatic naphtha, toluene, ethylene glycol, ethylene glycol monobutyl ether, diethylene glycol monoethyl ether, and/or xylene.

The solvent may be a polar solvent, such as water, brine, seawater, an alcohol (including straight chain or branched aliphatic, such as methanol, ethanol, propanol, isopropanol, butanol, 2-ethylhexanol, hexanol, octanol, decanol, 2-butoxyethanol, etc.), an alkylene glycol (such as methylene glycol, ethylene glycol, 1,2-propylene glycol, 1,3-propylene glycol, etc.), a glycol ether (such as diethyleneglycol monomethyl ether, ethylene glycol monobutyl ether, ethylene glycol dibutyl ether, etc.), a ketone (such as cyclohexanone or diisobutylketone), an ether (such as diethyl ether), an alkylene carbonate (such as propylene carbonate), N-methylpyrrolidinone (NMP), N,N-dimethylformamide, a polyol (such as glycerin), and the like.

Illustrative, non-limiting examples of non-polar solvents suitable for formulation with the composition include, but are not limited to, aliphatic hydrocarbons, such as pentane, hexane, cyclohexane, methylcyclohexane, heptane, decane, dodecane, diesel, and the like; aromatic hydrocarbons, such as toluene, xylene, and heavy aromatic naphtha; and fatty acid derivatives, such as acids, esters, and amides.

The solvent may be compatible with an arctic environment. For example, the solvent may comprise methanol, ethanol, ethylene glycol and/or glycerin, which can improve the anti-freeze properties of the composition.

The amount of solvent present in a composition of the present disclosure is not particularly limited. For example, a composition disclosed herein may comprise from about 0 wt. % to about 99 wt. %, from about 1 wt. % to about 99 wt. %, from about 5 wt. % to about 99 wt. %, from about 10 wt. % to about 99 wt. %, from about 20 wt. % to about 99 wt. %, from about 30 wt. % to about 99 wt. %, from about 40 wt. % to about 99 wt. %, from about 50 wt. % to about 99 wt. %, from about 60 wt. % to about 99 wt. %, from about 70 wt. % to about 99 wt. %, from about 80 wt. % to about 99 wt. %, or from about 90 wt. % to about 99 wt. % of the solvent or any combination of solvents.

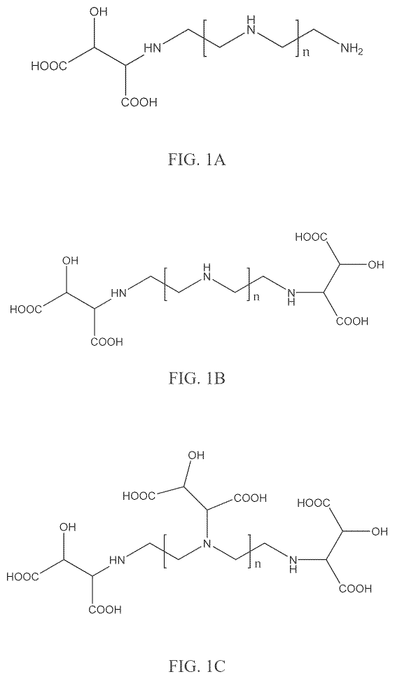

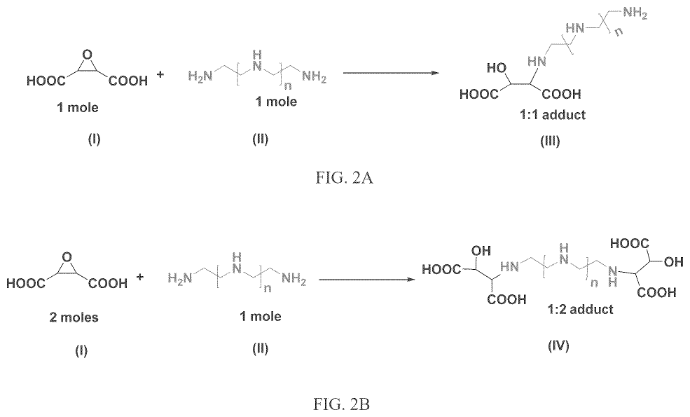

Synthesis of the polycarboxylated β-amino alcohols of the present disclosure may be carried out according to various synthetic methods known in the art. For example, synthesis can occur via a ring opening reaction of the epoxy succinic acid (I) with the polyamine (II), as shown in the reactions of FIGS. 2A and 2B. As shown, the reaction of 1 mole of epoxy succinic acid with 1 mole of polyamine in the reaction of FIG. 2A leads to the 1:1 adduct of FIG. 1A. The reaction of 2 moles of epoxy succinic acid with 1 mole of polyamine in the reaction of FIG. 2B leads to the 1:2 adduct of FIG. 1B. Similarly, the reaction of 3 moles of epoxy succinic acid with 1 mole of polyamine leads to the 1:3 adduct of FIG. 1C.

Reaction conditions for the ring opening reaction of the epoxy succinic acid (I) with the polyamine (II) can occur, for example, via an aqueous solution of disodium epoxy succinic acid being heated with the polyamine at about 80° C. for about 8 to about 12 hours.

In some embodiments, a polycarboxylated β-amino alcohol of the present disclosure is prepared by mixing the following reactants at the noted ratios.

| Product ID | Molar ratio | Chemistry description |
|---|---|---|
| Formula 1 | 1 | epoxysuccinic acid (ESA) |
| | 1 | PEHA |

In some embodiments, a polycarboxylated β-amino alcohol of the present disclosure is prepared by mixing the following reactants at the noted ratios.

| Product ID | Molar ratio | Chemistry description |
|---|---|---|
| Formula 2 | 1 | ESA |
| | 1 | TEPA |

In some embodiments, a polycarboxylated β-amino alcohol of the present disclosure is prepared by mixing the following reactants at the noted ratios.

| Product ID | Molar ratio | Chemistry description |
|---|---|---|
| Formula 3 | 1 | ESA |
| | 1 | TETA |

In some embodiments, a polycarboxylated β-amino alcohol of the present disclosure is prepared by mixing the following reactants at the noted ratios.

| Product ID | Molar ratio | Chemistry description |
|---|---|---|
| Formula 4 | 1 | ESA |
| | 1 | DETA |

In some embodiments, a polycarboxylated β-amino alcohol of the present disclosure is prepared by mixing the following reactants at the noted ratios.

| Product ID | Molar ratio | Chemistry description |
|---|---|---|
| Formula 5 | 2 | ESA |
| | 1 | PEHA |

In some embodiments, a polycarboxylated β-amino alcohol of the present disclosure is prepared by mixing the following reactants at the noted ratios.

| Product ID | Molar ratio | Chemistry description |
|---|---|---|
| Formula 6 | 2 | ESA |
| | 1 | TEPA |

In some embodiments, a polycarboxylated β-amino alcohol of the present disclosure is prepared by mixing the following reactants at the noted ratios.

| Product ID | Molar ratio | Chemistry description |
|---|---|---|
| Formula 7 | 2 | ESA |
| | 1 | TETA |

In some embodiments, a polycarboxylated β-amino alcohol of the present disclosure is prepared by mixing the following reactants at the noted ratios.

| Product ID | Molar ratio | Chemistry description |
|---|---|---|
| Formula 8 | 2 | ESA |
| | 1 | DETA |

In some embodiments, a composition disclosed herein comprises, consists of, or consists essentially of, one or more polycarboxylated β-amino alcohols. In some embodiments, a composition disclosed herein comprises, consists of, or consists essentially of, one or more polycarboxylated β-amino alcohols and one or more additives. In some embodiments, a composition disclosed herein comprises, consists of, or consists essentially of, one or more polycarboxylated β-amino alcohols and one or more solvents. In some embodiments, a composition disclosed herein comprises, consists of, or consists essentially of, one or more polycarboxylated-amino alcohols, one or more additives, and one or more solvents.

In some embodiments, compositions of the present disclosure may be prepared by combining the iron sulfide dissolver with a solvent to form a solution. If desired, additional additives may be added to the solution.

The compositions of the present disclosure may be used for dissolving iron sulfide and/or other inorganic salts and/or removing hydrocarbonaceous deposits in oil and gas applications. The compositions may be used in any industry where it is desirable to dissolve inorganic salts, such as iron sulfide, and/or remove hydrocarbonaceous deposits from a surface.

In some embodiments, the present disclosure provides a method of dissolving an inorganic salt deposit, such as an iron sulfide deposit, in an aqueous system. The method comprises adding a composition to the aqueous medium, wherein the composition comprises a polycarboxylated β-amino alcohol and/or a salt thereof. In some embodiments, the present disclosure provides a method of inhibiting corrosion of a metallic surface in an aqueous system. The method comprises adding a composition to the aqueous medium, wherein the composition comprises a polycarboxylated β-amino alcohol and/or a salt thereof.

In some embodiments, a method of the present disclosure may be carried out by treating a gas and/or liquid stream with an effective amount of a composition as described herein. The methods may be carried out in aqueous systems, oil systems and/or gas systems. For example, the compositions and methods may be used for dissolving iron sulfide deposits on heat exchanger surfaces. Certain methods may include applying a composition disclosed herein to a gas or liquid produced or used in the production, transportation, storage, and/or separation of crude oil or natural gas. In some embodiments, a composition may be applied to a gas stream used or produced in a coal-fired process, such as a coal-fired power plant. In certain embodiments, a composition may be applied to a gas or liquid produced or used in a waste-water process, a farm, a slaughterhouse, a landfill, a municipality waste-water plant, a coking coal process, and/or a biofuel process.

The compounds and compositions disclosed herein may be added to an aqueous medium. The aqueous medium may comprise water, gas, and/or liquid hydrocarbon. In some embodiments, a compound or composition may be added to a liquid hydrocarbon. The liquid hydrocarbon can be any type of liquid hydrocarbon including, but not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, and any combination thereof. In some embodiments, the fluid or gas may comprise a refined hydrocarbon product.

A fluid or gas treated with a composition of the present disclosure may be at any selected temperature, such as ambient temperature or an elevated temperature. The fluid (e.g., liquid hydrocarbon) or gas may be at a temperature of from about 40° C. to about 250° C. In some embodiments, the fluid or gas may be at a temperature of from about −50° C. to about 300° C., about 0° C. to about 200° C., about 10° C. to about 100° C., or about 20° C. to about 90° C. For example, the fluid or gas may be at a temperature of about −20° C., about −15° C., about −10° C., about −5° C., or about 0° C. In certain embodiments, the fluid or gas can be found in an arctic environment and can have a temperature and salinity typical of such an environment.

The compositions of the disclosure may be added to a fluid at various levels of water cut. For example, the water cut may be from about 0% to about 100% volume/volume (v/v), from about 1% to about 80% v/v, or from about 1% to about 60% v/v. The fluid may be an aqueous medium that contains various levels of salinity. For example, the fluid may have a salinity of about 0% to about 25%, about 1% to about 24%, or about 10% to about 25% weight/weight (w/w) total dissolved solids (TDS).

The fluid and/or gas to which the compositions of the disclosure are introduced can be contained in and/or exposed to many different types of devices. For example, the fluid and/or gas may be contained in a device or apparatus that transports fluid or gas from one point to another, such as an oil and/or gas pipeline. The device or apparatus can be part of an oil and/or gas refinery, such as a pipeline, a separation vessel, a dehydration unit, or a gas line.

The compositions can be introduced to large diameter flow lines of from about 1 inch to about 4 feet in diameter, small gathering lines, small flow lines and headers. The fluid can be contained in and/or exposed to an apparatus or device used in oil extraction and/or production, such as a wellhead. The device or apparatus may be part of a coal-fired power plant. The device or apparatus may be a scrubber (e.g., a wet flue gas desulfurizer, a spray dry absorber, a dry sorbent injector, a spray tower, a contact or bubble tower, or the like). The device or apparatus may be a cargo vessel, a storage vessel, a holding tank, or a pipeline connecting the tanks, vessels, or processing units.

The compositions may be introduced into a fluid or gas by any appropriate method for ensuring dispersal through the fluid or gas. In some embodiments, a composition may be added to the hydrocarbon fluid before the hydrocarbon fluid contacts a surface in the system. The composition may be added at a point in a flow line upstream from the point at which iron sulfide is to be dissolved. The compositions may be injected/added using mechanical equipment, such as chemical injection pumps, piping tees, injection fittings, atomizers, quills, and the like. In certain embodiments, the compositions of the disclosure may be pumped into an oil and/or gas pipeline using an umbilical line. In other embodiments, a capillary injection system may be used to deliver the composition to a selected fluid.

The compositions may be injected into a stream as an aqueous or non-aqueous solution, a mixture, or a slurry. The compositions may be applied to a fluid or gas to provide any selected concentration of components. For example, the composition may be added to a flow line to provide an effective treating dose of the desired component, such as iron sulfide dissolver, from about 0.01 ppm to about 50,000 ppm. The compositions may be applied to a fluid or gas to provide a concentration of iron sulfide dissolver of, for example, about 1 ppm to about 50,000 ppm, about 1 ppm to about 40,000 ppm, about 1 ppm to about 30,000 ppm, about 1 ppm to about 20,000 ppm, about 1 ppm to about 10,000, about 1 ppm to about 5,000 ppm, about 1 ppm to about 1,000 ppm, about 10 ppm to about 5,000 ppm, about 10 ppm to about 1,000 ppm, about 10 ppm to about 700 ppm, about 10 ppm to about 500 ppm, about 25 ppm to about 1,000 ppm, or about 50 ppm to about 500 ppm.

In accordance with the methods disclosed herein, a compound, additive, and/or composition may be applied continuously, in batch, or a combination thereof. For example, a dosage rate for continuous treatment may range from about 10 ppm to about 500 ppm or about 10 ppm to about 200 ppm. A dosage rate for batch treatments may range from, for example, about 10 ppm to about 400,000 ppm or about 10 ppm to about 20,000 ppm. The composition, compound, and/or additive can also be applied as a pill to a pipeline, for example, to provide a high dose (e.g., about 20,000 ppm) of a component, such as the iron sulfide dissolver, of the composition.

The foregoing may be better understood by reference to the following examples, which are intended for illustrative purposes and are not intended to limit the scope of the disclosure or its application in any way.

### EXAMPLES

The ability of various polycarboxylated β-amino alcohols (Formulae 1-8 above) to dissolve iron sulfide was determined. One mole of ferrous chloride (FeCl₂) was reacted with one mole of sodium sulfide (Na₂S) to produce 1 mole of iron sulfide (FeS) suspended in deionized water. The FeS composition containing approximately 30 ppm Fe was maintained at about 65° C. for about 10 minutes. Then, a polycarboxylated β-amino alcohol was introduced at about 100 ppm. Treated samples were returned to the hot water bath for about 30 minutes. Then, the treated sample was removed from the hot water bath and allowed to cool to room temperature for about 2 to about 4 hours. Next, the samples were shaken to ensure resuspension of the FeS. The suspensions were subsequently filtered through a 0.2 μm filter with solubilized iron captured in the water phase and submitted for analysis of the filtered residue by Inductively Coupled Argon Plasma Analysis. In addition to the candidate treated samples, an untreated sample of the FeS suspension was included for analysis, which served as the control sample (Blank).

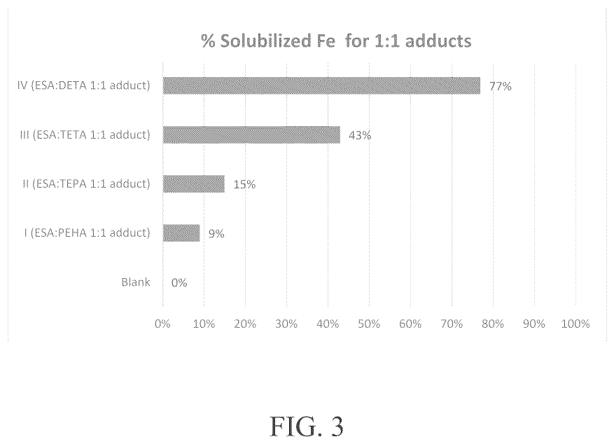

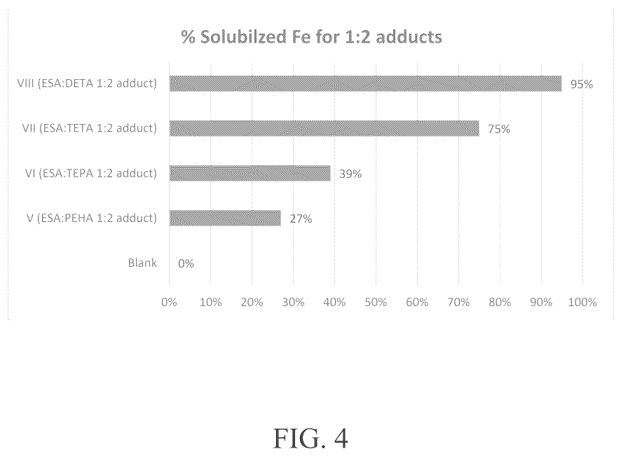

The iron sulfide solubilization performance of various polycarboxylated β-amino alcohol polymers at about 100 ppm dosage was determined and reported as percent (%) solubilized Fe. The results are shown in FIGS. 3-5.

As can be seen, the adducts with lower chain polyamines exhibited superior performance as compared to their longer chain counterparts. For example, adducts having DETA performed better than adducts having TETA, adducts having TETA performed better than adducts having TEPA, and adducts having TEPA performed better than adducts having PEHA.

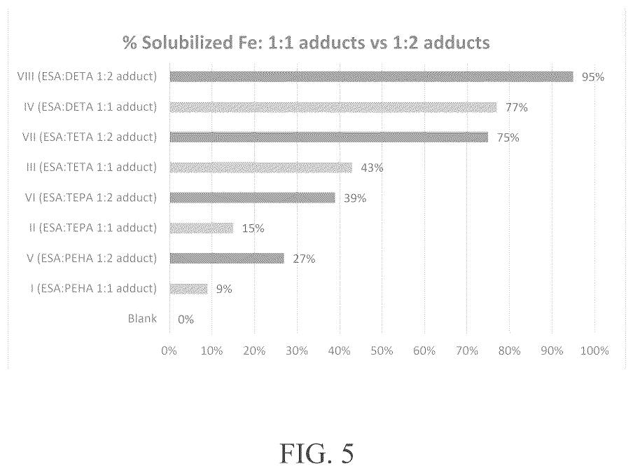

It can also be seen that the 1:2 adducts performed better than their respective 1:1 adduct (see FIG. 5).

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a polymer” is intended to include “at least one polymer” or “one or more corrosion polmyers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of dissolving an inorganic salt deposit in an aqueous medium, comprising:
adding a polycarboxylated β-amino alcohol polymer to the aqueous medium, and
dissolving at least a portion of the inorganic salt deposit.

2. The method of claim 1, wherein the polycarboxylated β-amino alcohol polymer is selected from the group consisting of 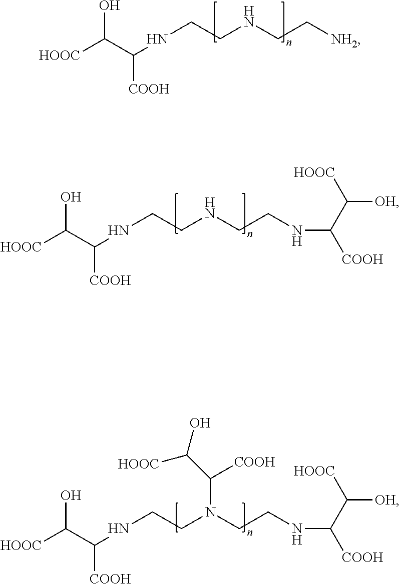
and any combination thereof, wherein n is an integer selected from 0 to 1,000.

3. The method of claim 1, wherein the inorganic salt deposit comprises iron sulfide.

4. The method of claim 1, wherein the polycarboxylated β-amino alcohol polymer comprises a weight average molecular weight of about 200 Da to about 50,000 Da.

5. The method of claim 1, further comprising adding an additive to the medium, wherein the additive is selected from the group consisting of an asphaltene inhibitor, a paraffin inhibitor, a scale inhibitor, an emulsifier, a water clarifier, a dispersant, an emulsion breaker, a hydrogen sulfide scavenger, a sulfur-containing compound, a gas hydrate inhibitor, a biocide, an antifoam, a pH modifier, a corrosion inhibitor, a surfactant, and any combination thereof.

6. The method of claim 1, wherein a composition comprises the polycarboxylated β-amino alcohol polymer.

7. The method of claim 6, wherein the composition comprises a solvent selected from the group consisting of an alcohol, a hydrocarbon, a ketone, an ether, an alkylene glycol, a glycol ether, an amide, a nitrile, a sulfoxide, an ester, water, and any combination thereof.

8. The method of claim 1, wherein the aqueous medium comprises water, a gas, a liquid hydrocarbon, or any combination thereof.

9. The method of claim 1, wherein a surface in contact with the aqueous medium comprises the inorganic salt deposit.

10. The method of claim 6, wherein the composition comprises from about 0.1 wt. % to about 99 wt. % of the polycarboxylated β-amino alcohol polymer.

11. The method of claim 6, wherein the composition consists of or consists essentially of the polycarboxylated β-amino alcohol polymer.

12. The method of claim 1, further comprising adding from about 1 ppm to about 20,000 ppm of the polycarboxylated β-amino alcohol polymer to the aqueous medium.

13. The method of claim 1, wherein the polycarboxylated β-amino alcohol polymer is prepared by reacting an epoxide with a polyamine.

14. The method of claim 13, wherein the epoxide and the polyamine are reacted at a molar ratio of about 1:1 to about 5:1.

15. The method of claim 13, wherein the epoxide is epoxysuccinic acid.

16. The method of claim 13, wherein the polyamine is selected from the group consisting of pentaethylenehexamine (PEHA), tetraethylenepentamine (TEPA), triethylenetetramine (TETA), diethylenetriamine (DETA), and any combination thereof.

17. A polycarboxylated polymer represented by Formula I: 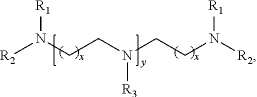
wherein x is an integer from about 1 to about 10; y is an integer from about 0 to about 100; R₁=CH(COOM)-CH(OH)(COOM); R₂=H or R₁; R₃=R₂ or —(CH₂)₂—NR₁R₂; z is an integer from about 1 to about 10; and M=H, Na, K, or Li.

18. The polycarboxylated polymer of claim 17, wherein x is an integer from about 1 to about 5; y is an integer from about 1 to about 50; R₁=CH(COOM)-CH(OH)(COOM); R₂=H or R₁; R₃=R₂ or —(CH₂)z-NR₁R₂; z is an integer from about 1 to about 10; and M is H or Na.

19. The polycarboxylated polymer of claim 17, wherein x is an integer from about 1 to about 5; y is an integer from about 1 to about 50; R₁=CH(COOM)-CH(OH)(COOM); R₂=H; R₃=R₂; and M is H or Na.

20. The polycarboxylated polymer of claim 17, wherein x is an integer from about 1 to about 5; y is an integer from about 1 to about 50; R₁=CH(COOM)-CH(OH)(COOM); R₂=R₁; R₃=—(CH₂) z-NR₁R₂; z is an integer from about 1 to about 10; and M is H or Na.
